(19) United States
(12) Patent Application Publication
(10) Pub. No.: US 2019/0142036 A1
(43) Pub. Date: May 16, 2019

(54) Lemon-Flavored Beverage, Lemon-Flavored Beverage Base, Method for Producing Lemon-Flavored Beverage, Method for Producing Lemon-Flavored Beverage Base, and Method for Improving Flavor of Lemon-Flavored Beverage

(71) Applicant: Sapporo Holdings Limited, Tokyo (JP)

(72) Inventors: Kazuki Maruyama, Tokyo (JP); Koji Takatera, Aichi (JP)

(73) Assignee: Sapporo Holdings Limited, Tokyo (JP)

(21) Appl. No.: 16/301,221

(22) PCT Filed: Feb. 24, 2017
(86) PCT No.: PCT/JP2017/007255

§ 371 Date: Nov. 13, 2018

(30) Foreign Application Priority Data
May 11, 2016 (JP) 2016-095356

(51) Int. Cl. A23L 2/56; C12G 3/06; A23L 2/02

(52) U.S. Cl. CPC A23L 2/56; A23V 2002/00; A23L 2/02; C12G 3/06

(57) ABSTRACT

Provided are a lemon-flavored beverage having a lemon flower-like aroma, a lemon-flavored beverage base, a method for producing a lemon-flavored beverage, a method for producing a lemon-flavored beverage base, and a method for improving the flavor of a lemon-flavored beverage. In the lemon-flavored beverage according to the present invention, the content of citral is 10 to 20000 ppb, and the content of methylanthranilate is 30 to 5000 ppb and/or the content of indole is 2 to 500 ppb. In the lemon-flavored beverage base according to the present invention, in a case where the contents of citral, methylanthranilate, and indole are X ppb, Y ppb, and Z ppb, respectively, and the dilution ratio is D fold, X/D is 10 to 20000, and Y/D is 30 to 5000 and/or Z/D is 2 to 500.

### TECHNICAL FIELD

The present invention relates to a lemon-flavored beverage, a lemon-flavored beverage base, a method for producing a lemon-flavored beverage, a method for producing a lemon-flavored beverage base, and a method for improving the flavor of a lemon-flavored beverage.

### BACKGROUND ART

Having a fresh and fruity taste and aroma and being favored by many people, lemon has been used in a wide range of beverages . Moreover, the tastes and aromas of lemon-flavored beverages have heretofore been studied and developed.

For example, Patent Literature 1 discloses a lemon-flavored beverage which contains citral, limonene, y-terpinene, and a-terpinolene and in which the relation between (Y) the total content (ppm) of limonene, y-terpinene, and a-terpinolene in the beverage and (X) the days (the number of days) elapsed since the production of the lemon-flavored beverage is −0.0047X+0.89≤Y≤−0.021X+10.35, where X≥0 and Y≥0.

### CITATION LIST

### Patent Literature

Patent Literature 1: Japanese Patent Application Publication No. 2015-123008

### SUMMARY OF INVENTION

### Technical Problem

Conventional techniques related to lemon-flavored beverages including the technique according to Patent Literature 1 have been developed by focusing on the flavor of the fruit of lemon.

Here, the diversity of consumers' preferences has increased. To cope with this increase in diversity in preference, it is necessary to develop products by studying lemon flavors in more details.

The present inventors were strikingly impressed by an aroma released when a lemon flower was teared. This has led the present inventors to the idea that they may be able to satisfy one of the variety of consumers' needs if they can create a lemon-flavored beverage having the aroma of the flower of the lemon plant (in particular, the flower petals: hereinafter, referred to as “lemon flower” as appropriate), instead of the aroma of the fruit of the lemon plant.

Thus, an object of the present invention is to provide a lemon-flavored beverage having a lemon flower-like aroma, a lemon-flavored beverage base, a method for producing a lemon-flavored beverage, a method for producing a lemon-flavored beverage base, and a method for improving the flavor of a lemon-flavored beverage.

### Solution to Problem

The present inventors actually extracted various substances from lemon flower petals and studied characteristic features of aromas imparted to beverages by using these substances alone and in combination. As a result, the present inventors identified three substances necessary to impart a lemon flower-like aroma and thereby created the present invention.

The above problem can be solved by the following solutions.
(1) A lemon-flavored beverage satisfying a condition that a content of citral is 10 to 20000 ppb, and at least one of a condition that a content of methylanthranilate is 30 to 5000 ppb and a condition that a content of indole is 2 to 500 ppb.
(2) The lemon-flavored beverage according to the above solution 1, wherein the content of citral is 100 to 10000 ppb.
(3) The lemon-flavored beverage according to the above solution 1 or 2, wherein the content of methylanthranilate is 50 to 3000 ppb.
(4) The lemon-flavored beverage according to any one of the above solutions 1 to 3, wherein the content of indole is 10 to 200 ppb.
(5) The lemon-flavored beverage according to any one of the above solutions 1 to 4, wherein the lemon-flavored beverage contains alcohol.
(6) A lemon-flavored beverage base containing citral and at least one of methylanthranilate and indole, wherein, in a case where a content of the citral is X ppb, a content of the methylanthranilate is Y ppb, a content of the indole is Z ppb, and a dilution ratio is D fold, the lemon-flavored beverage base satisfies a condition that X/D is 10 to 20000 and at least one of a condition that Y/D is 30 to 5000 and a condition that Z/D is 2 to 500.
(7) A method for producing a lemon-flavored beverage, comprising the step of setting a content of citral and a content of at least one of methylanthranilate and indole within following respective ranges: (1) the content of citral: 10 to 20000 ppb; (2) the content of methylanthranilate: 30 to 5000 ppb; and (3) the content of indole: 2 to 500 ppb.
(8) A method for producing a lemon-flavored beverage base containing citral and at least one of methylanthranilate and indole, comprising the step of, in a case where a content of the citral is X ppb, a content of the methylanthranilate is Y ppb, a content of the indole is Z ppb, and a dilution ratio is D fold, setting X/D and at least one of Y/D and Z/D within following ranges: (1) the X/D: 10 to 20000; (2) the Y/D: 30 to 5000; and (3) the Z/D: 2 to 500.
(9) A method for improving a flavor of a lemon-flavored beverage, comprising adjusting a content of citral and a content of at least one of methylanthranilate and indole in the lemon-flavored beverage such that the contents are within following respective ranges: (1) the content of citral: 10 to 20000 ppb; (2) the content of methylanthranilate: 30 to 3000 ppb; and (3) the content of indole: 2 to 500 ppb.

### Advantageous Effects of Invention

In the lemon-flavored beverage according to the present invention, the content of citral and the content of at least one of methylanthranilate and indole are set within respective predetermined ranges. In this way, the lemon-flavored beverage exhibits a lemon flower-like aroma.

In the lemon-flavored beverage base according to the present invention, X/D and at least one of Y/D and Z/D are set within respective predetermined ranges. In this way, a lemon-flavored beverage after dilution exhibits a lemon flower-like aroma.

The method for producing a lemon-flavored beverage according to the present invention includes the step of setting the content of citral and the content of at least one of methylanthranilate and indole within respective predetermined ranges. In this way, the method for producing a lemon-flavored beverage can produce a lemon-flavored beverage having a lemon flower-like aroma.

The method for producing a lemon-flavored beverage base according to the present invention includes the step of setting X/D and at least one of Y/D and Z/D within respective predetermined ranges. In this way, the method for producing a lemon-flavored beverage base can produce a lemon-flavored beverage base that can be diluted as a lemon-flavored beverage having a lemon flower-like aroma.

The method for improving the flavor of a lemon-flavored beverage according to the present invention includes setting the content of citral and the content of at least one of methylanthranilate and indole in a lemon-flavored beverage within respective predetermined ranges. In this way, the method for improving the flavor of a lemon-flavored beverage can make the aroma of a lemon-flavored beverage a lemon flower-like aroma and thereby improve the flavor.

### BRIEF DESCRIPTION OF DRAWING

FIG. 1 is a flowchart explaining the content of a method for producing a lemon-flavored beverage according to an embodiment of the present invention.

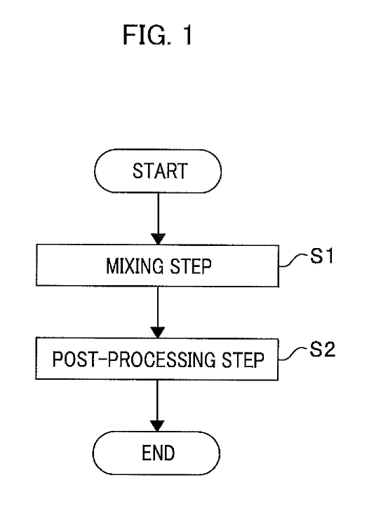

### DESCRIPTION OF EMBODIMENT

Hereinafter, an embodiment of a lemon-flavored beverage, a lemon-flavored beverage base, a method for producing a lemon-flavored beverage, a method for producing a lemon-flavored beverage base, and a method for improving the flavor of a lemon-flavored beverage according to the present invention will be described.

### [Lemon-Flavored Beverage]

The lemon-flavored beverage according to this embodiment contains citral and at least one of methylanthranilate and indole.

### (Citral)

Citral (citral) is a monoterpene aldehyde contained in lemon and orange. Also, citral is a substance necessary to make the aroma of the lemon-flavored beverage a lemon flower-like aroma and, in particular, a substance that contributes greatly to imparting a lemon-like aroma.

The content of citral in the lemon-flavored beverage is 10 ppb or more, preferably 100 ppb or more, more preferably 200 ppb or more, and even more preferably 500 ppb or more. With the content of citral at a predetermined value or more, it is possible to make the aroma of the lemon-flavored beverage a lemon-like aroma.

Also, the content of citral is 20000 ppb or less, preferably 10000 ppb or less, and more preferably 5000 ppb or less. With the content of citral at a predetermined value or less, it is possible to avoid a situation where the lemon-like character of the aroma of the lemon-flavored beverage is so strong that the flowery character decreases and the lemon-flavored beverage does not have a lemon flower-like aroma.

### (Methylanthranilate)

Methylanthranilate is an ester of anthranilic acid and methanol.

Also, like indole to be described later, methylanthranilate is a substance that can impart a flowery aroma to the lemon-flavored beverage and in particular can make the aroma of the lemon-flavored beverage a gorgeous lemon flower-like aroma when contained along with citral.

In the case where the lemon-flavored beverage contains methylanthranilate, the content of methylanthranilate is 30 ppb or more, preferably 50 ppb or more, more preferably 100 ppb or more, even more preferably 300 ppb or more, and particularly preferably 500 ppb or more. With the content of methylanthranilate at a predetermined value or more, it is possible to make the aroma of the lemon-flavored beverage a lemon flower-like aroma in combination with citral.

Also, in the case where the lemon-flavored beverage contains methylanthranilate, the content of methylanthranilate is 5000 ppb or less, preferably 3000 ppb or less, and more preferably 1000 ppb or less. With the content of methylanthranilate at a predetermined value or less, it is possible to avoid a situation where the aroma of the lemon-flavored beverage is a poorly balanced aroma.

### (Indole)

Indole is an organic compound with a structure in which a benzene ring and a pyrrole ring are fused to each other. Also, like methylanthranilate mentioned above, indole is a substance that can impart a flowery aroma to the lemon-flavored beverage and in particular can make the aroma of the lemon-flavored beverage a slightly heavy lemon flower-like aroma when contained along with citral. Note that indole has been known as a substance having a negative foul odor. Thus, the fact that the combination with citral enables the lemon-flavored beverage to exhibit an aroma as described above has been completely unimaginable.

In the case where the lemon-flavored beverage contains indole, the content of indole is 2 ppb or more, preferably 5 ppb or more, more preferably 10 ppb or more, even more preferably 20 ppb or more, and particularly preferably 50 ppb or more . With the content of indole at a predetermined value or more, it is possible to make the aroma of the lemon-flavored beverage a lemon flower-like aroma in combination with citral.

Also, in the case where the lemon-flavored beverage contains indole, the content of indole is 500 ppb or less, preferably 200 ppb or less, and more preferably 100 ppb or less. With the content of indole at a predetermined value or less, it is possible to avoid a situation where the aroma of the lemon-flavored beverage is a poorly balanced aroma.

The lemon-flavored beverage according to this embodiment is only required to contain one of methylanthranilate and indole in the corresponding content range described above but may also contain both.

Note that in the case where the lemon-flavored beverage according to this embodiment contains both methylanthranilate and indole, the lemon-flavored beverage may contain both in their respective content ranges described above or contain one in the corresponding content range described above while containing the other in an amount less than the corresponding lowest content described above.

For the lemon-flavored beverage according to this embodiment, the contents of citral, methylanthranilate, and indole mentioned above can be measured by the following method.

A sample is extracted with dichloromethane and the target components are concentrated. Then, the target components can be quantified with a GC-MS instrument manufactured by Agilent Technologies, Inc. (GC: 7890A, MS: 5975C inert XL), for example. The conditions for the GC/MS are as follows. First, the oven is held at 40° C. for 2 minutes, then its temperature is raised at 2° C./min to 200° C. and held for 48 minutes. The inlet temperature is 250° C., and the split ratio is 10:1. The column used is DB-WAX (manufactured by Agilent Technologies, Inc., with an internal diameter of 0.25 mm, a film thickness of 0.25pm, and a column length of 60 m), and helium is caused to flow as the carrier gas at 1.2 ml/min. The MS interface temperature may be 280° C., and the ion source temperature may be 230° C.

Note that in this description, 1 ppb is 1×10⁻⁷ w/w % to be specific.

### (Alcohol)

The lemon-flavored beverage according to this embodiment may contain alcohol.

The alcohol maybe any alcohol as long as it is drinkable, and its kind, production method, ingredients, and so on are not limited. Nevertheless, the alcohol is preferably a distilled alcohol or a brewed alcohol. Examples of the distilled alcohol includes various spirits such as shochu, brandy, vodka, and whisky, and raw alcohol, and it is possible to use one of them or a combination of two or more of them. As the brewed alcohol, it is possible to use one of bear, low-malt beer, fruit wine, fortified fruit wine, and the like or a combination of two of more of them, for example.

Note that in this description, the alcohol is ethanol unless otherwise noted.

### (Alcohol Content)

The alcohol content of the lemon-flavored beverage according to this embodiment is not particularly limited. However, in the case the lemon-flavored beverage according to this embodiment is an alcoholic beverage, its alcohol content is preferably 1 v/v % or more and more preferably 3 v/v % or more. Also, the alcohol content of the lemon-flavored beverage according to this embodiment is preferably 20 v/v % or less and more preferably 10 v/v % or less.

Further, the alcohol content can be adjusted by how much the above-mentioned drinking alcohol is to be contained.

The alcohol content of the lemon-flavored beverage according to this embodiment can be measured based on the Analysis Methods Prescribed by the National Tax Agency (Directive), 3 Seishu, 3-4 Alcohol Content (Method with Vibration-Type Density Meter), for example.

### (Fizziness)

The lemon-flavored beverage according to this embodiment may not be fizzy or be fizzy. Here, in this embodiment, being fizzy means having a gas pressure of 0.5 kg/cm² or more at 20° C., not being fizzy means having a gas pressure of less than 0.5 kg/cm² at 20° C.

### (Other Matters)

A sweetener, high-intensity sweetener, antioxidant, flavoring, acidulant, salt, dietary fiber, fruit juice, and so on (hereinafter, referred to as “additives” as appropriate) that are usually added to beverages can be added to the lemon-flavored beverage according to this embodiment within such an extent as not to hinder the desired advantageous effect of the present invention. As the sweetener, it is possible to use, for example, high-fructose corn syrup, glucose, galactose, mannose, fructose, lactose, sucrose, maltose, glycogen, starch, and so on. As the high-intensity sweetener, it is possible to use, for example, neotame, acesulfame potassium, sucralose, saccharin, sodium saccharin, disodium glycyrrhizate, cyclamate, dulcin, stevia, glycyrrhizin, thaumatin, monellin, aspartame, alitame, and so on. As the antioxidant, it is possible to use, for example, vitamin C, vitamin E, polyphenols, and so on are usable, for example. As the acidulant, it is possible to use, for example, adipic acid, citric acid, trisodium citrate, glucono delta-lactone, gluconic acid, potassium gluconate, sodium gluconate, succinic acid, monosodium succinate, disodium succinate, sodium acetate, DL-tartaric acid, L-tartaric acid, DL-sodium tartrate, L-sodium tartrate, carbon dioxide, lactic acid, sodium lactate, glacial acetic acid, fumaric acid, monosodium fumarate, DL-malic acid, DL-sodium malate, phosphoric acid, and so on. As the salt, it is possible to use, for example, sodium chloride, acidic potassium phosphate, acidic calcium phosphate, ammonium phosphate, magnesium sulfate, calcium sulfate, potassium metabisulfite, calcium chloride, magnesium chloride, potassium nitrate, ammonium sulfate, and so on. As the dietary fiber, it is possible to use, for example, indigestible dextrin, pectin, polydextrose, guar gum degradation products, and so on. As the fruit juice, it is possible to use, for example, various types of fruit juices such as concentrated fruit juice, single-strength fruit juice, and straight fruit juice, fruit purees (semi-liquid products obtained by grounding and/or pureeing cooked fruit or raw fruit), liquids obtained by diluting, concentrating, or mixing these, and so on. Further, lemon may be the only ingredient of the fruit juice or one or more kinds of fruits other than lemon may be the ingredients of the fruit juice.

Moreover, as the citral, methylanthranilate, indole, alcohol, and additives mentioned above, it is possible to use commonly commercially available products.

Note that while the citral, methylanthranilate, and indole may be ones obtained by any production method, it is also possible to use ones obtained from lemon flower petals via solvent extraction (extraction with ethanol or the like), for example.

As described above, in the lemon-flavored beverage according to this embodiment, the content of citral and the content of at least one of methylanthranilate and indole are within respective predetermined ranges. Thus, the lemon-flavored beverage according to this embodiment exhibits a lemon flower-like aroma.

### [Lemon-Flavored Beverage Base]

The lemon-flavored beverage base according to this embodiment can be the above-described lemon-flavored beverage by being diluted with the later-described mixer.

Note that when provided to a customer, a restaurant, or the like, the lemon-flavored beverage base according to this embodiment may be provided in the form of a beverage base (RTS: Ready To Serve) and then diluted with the mixer, or diluted with the mixer and then provided in the form of a beverage (RTD: Ready to Drink).

In the following description of the lemon-flavored beverage base according to this embodiment, description of its features common to the above-described lemon-flavored beverage will be omitted, and different features (such as contents in particular) will be mainly described.

### (Citral)

In a case where the content of citral in the lemon-flavored beverage base is X ppb and the dilution ratio is D fold, X/D is 10 or more, preferably 100 or more, more preferably 200 or more, and even more preferably 500 or more. Also, X/D is 20000 or less, preferably 10000 or less, and more preferably 5000 or less.

### (Methylanthranilate)

In a case where the content of methylanthranilate in the lemon-flavored beverage base is Y ppm and the dilution ratio is D fold, Y/D is 30 or more, preferably 50 or more, more preferably 100 or more, even more preferably 300 or more, and particularly preferably 500 or more . Also, Y/D is 5000 or less, preferably 3000 or less, and more preferably 1000 or less.

### (Indole)

In a case where the content of indole in the lemon-flavored beverage base is Z ppb and the dilution ratio is D fold, Z/D is 2 or more, preferably 5 or more, more preferably 10 or more, even more preferably 20 or more, and particularly preferably 50 or more. Also, Z/D is 500 or less, preferably 200 or less, and more preferably 100 or less.

### (Alcohol Content)

The alcohol content of the lemon-flavored beverage base is not particularly limited. In a case where the alcohol content of the lemon-flavored beverage base is A v/v % and the dilution ratio is D fold, A/D is preferably 1 or more and more preferably 3 or more. Also, A/D is preferably 20 or less and more preferably 10 or less.

### (Mixer)

The mixer is a material used to dilute the lemon-flavored beverage base according to this embodiment.

Examples of the mixer include alcohol, water, carbonated water, hot water, ice, fruit juices, beverages with a fruit juice(s), cow milk, tea, and so on, and it is possible to use one of them or a combination of two or more of them.

Note that the lemon-flavored beverage base according to this embodiment may be diluted 1.2 to 20 fold, preferably 1.5 to 10 fold, and more preferably 2 to 5 fold with the mixer.

As described above, in the lemon-flavored beverage base according to this embodiment (dilution ratio: D fold), X/D and at least one of Y/D and Z/D are within respective predetermined ranges. In other words, the content of citral and the content of at least one of methylanthranilate and indole in the lemon-flavored beverage after dilution (in a to-be-drunk state) are within their respective predetermined ranges mentioned above. In this way, the lemon-flavored beverage after dilution exhibits a lemon flower-like aroma.

### [Lemon-Flavored Beverage Filled in Container and Lemon-Flavored Beverage Base Filled in Container]

The lemon-flavored beverage and the lemon-flavored beverage base to be filled in a container according to this embodiment can be filled in various containers and provided. By filling the lemon-flavored beverage and the lemon-flavored beverage base in any of various containers, deterioration in their quality due to long-term storage can be well prevented. Note that the container may be any container as long as it can be tightly closed, and what is called a can container or a keg container, made of a metal (such as aluminum or steel), can be employed. Alternatively, a glass container, a plastic container, a paper container, a pouch container, and so on can be employed as the container. The capacity of the container is not particularly limited. Currently commercially available containers with any capacities can be employed. Note that it is preferable to employ a metal container for its ability to completely block gases, moisture, and light rays and maintain stable quality at normal temperature for a long period.

Also, in the case where the lemon-flavored beverage base is filled in any of the various containers, that container may be provided with a sign (e.g. dilution ratio or the like) indicating that the lemon-flavored beverage base maybe diluted with any of the above mixers or the like and drunk.

### [Method for Producing Lemon-Flavored Beverage and Method for Producing Lemon-Flavored Beverage Base]

Next, the method for producing a lemon-flavored beverage and the method for producing a lemon-flavored beverage base according to this embodiment will be described.

The method for producing a lemon-flavored beverage and the method for producing a lemon-flavored beverage base according to this embodiment include a mixing step S1 and a post-processing step S2.

In the mixing step S1, water, citral, methylanthranilate, indole, drinking alcohol, additives, and so on are introduced as desired into a mixing tank to produce a mixed liquid.

In this mixing step S1, the ingredients may just need to be mixed and adjusted such that the contents of citral, methylanthranilate, and indole, X/D, Y/D, and Z/D are their respective predetermined ranges mentioned above.

Then, in the post-processing step S2, processes such as filtering, sterilization, and filling the lemon-flavored beverage or the lemon-flavored beverage base into a container, for example, are selectively performed as needed.

Note that the filtering process in the post-processing step S2 can be performed with a commonly used filter or strainer. Further, it is preferable to perform the sterilization process in the post-processing step S2 by plate sterilization in view of the processing rate and so on. However, the sterilization process is not limited to this and can employ any other method as long as it can perform a similar process. Furthermore, in the filling process in the post-processing step S2, it is preferable to fill the lemon-flavored beverage or the lemon-flavored beverage base inside a clean room with its cleanliness maintained at the degree at which filling is usually performed in the production of beverage products.

Note that the processes performed in the mixing step S1 and the post-processing step S2 can be performed in a facility commonly used to produce RTD and RTS beverages and the like.

Also, before the mixing step S1, there may be an extraction step of extracting citral, methylanthranilate, and indole from lemon flower petals via solvent extraction or the like.

As described above, the method for producing a lemon-flavored beverage according to this embodiment includes a step of setting the content of citral and the content of at least one of methylanthranilate and indole within respective predetermined ranges. Thus, the method for producing a lemon-flavored beverage can produce a lemon-flavored beverage having a lemon flower-like aroma. Also, the method for producing a lemon-flavored beverage base according to this embodiment includes a step of setting X/D and at least one of Y/D and Z/D within respective predetermined ranges. Thus, the method for producing a lemon-flavored beverage base can produce a lemon-flavored beverage base having a lemon flower-like aroma.

### [Method for Improving Flavor of Lemon-Flavored Beverage]

Next, the method for improving the flavor of a lemon-flavored beverage according to this embodiment will be described.

The method for improving the flavor of a lemon-flavored beverage according to this embodiment is characterized by adjusting the content of citral and the content of at least one of methylanthranilate and indole in the lemon-flavored beverage such that the contents are within respective predetermined ranges.

Specifically, in the method for improving the flavor of a lemon-flavored beverage according to this embodiment, the content of citral in the lemon-flavored beverage is set to 10 ppb or more, preferably 100 ppb or more, more preferably 200 ppb or more, and even more preferably 500 ppb or more. Also, the content of citral in the lemon-flavored beverage is set to 20000 ppb or less, preferably 10000 ppb or less, and more preferably 5000 ppb or less.

Further, in the method for improving the flavor of a lemon-flavored beverage according to this embodiment, the content of methylanthranilate in the lemon-flavored beverage is set to 30 ppb or more, preferably 50 ppb or more, more preferably 100 ppb or more, even more preferably 300 ppb or more, and particularly preferably 500 ppb or more. Also, the content of methylanthranilate in the lemon-flavored beverage is set to 5000 ppb or less, preferably 3000 ppb or less, and more preferably 1000 ppb or less.

Further, in the method for improving the flavor of a lemon-flavored beverage according to this embodiment, the content of indole in the lemon-flavored beverage is set to 2 ppb or more, preferably 5 ppb or more, more preferably 10 ppb or more, even more preferably 20 ppb or more, and particularly preferably 50 ppb or more. Also, the content of indole in the lemon-flavored beverage is set to 500 ppb or less, preferably 200 ppb or less, and more preferably 100 ppb or less.

As described above, in the method for improving the flavor of a lemon-flavored beverage according to this embodiment, the content of citral and the content of at least one of methylanthranilate and indole in the lemon-flavored beverage are set within respective predetermined ranges. Thus, the method for improving the flavor of a lemon-flavored beverage can make the aroma of the lemon-flavored beverage a lemon flower-like aroma and thus improve the flavor.

### EXAMPLES

Next, the present invention will be described by exemplarily presenting examples satisfying the requirements of the present invention and comparative examples not satisfying the requirements.

### Example 1

First, in example 1, the impact of the contents of citral and methylanthranilate on evaluations will be checked.

### (Preparation of Samples)

Sample liquids were prepared by mixing citral, methylanthranilate, and distilled water.

### (Contents of Test)

Three trained professional panelists scored each of “lemon-like character”, “lemon flower-like character”, and “overall evaluation” of each sample produced by the above method on a five-point scale from 1 to 5 in accordance with the following set of evaluation criteria, and the average of the scores was calculated.

Note that in each test, the sample was evaluated by checking its aromas (by checking its so-called top note) without drinking it.

### (Lemon-Like Character: Evaluation Criteria)

5 points: Very strong lemon-like aroma was present.
4 points: Strong lemon-like aroma was present.
3 points: Lemon-like aroma was present.
2 points: Faint lemon-like aroma was present.
1 point: No lemon-like aroma was present.

### (Lemon Flower-Like Character: Evaluation Criteria)

5 points: Very strong lemon flower-like aroma was present.
4 points: Strong lemon flower-like aroma was present.
3 points: Lemon flower-like aroma was present.
2 points: Faint lemon flower-like aroma was present.
1 point: No lemon flower-like aroma was present.

### (Overall Evaluation: Evaluation Criteria)

5 points: Lemon-like aroma and lemon flower-like aroma were balanced very well.
4 points: Lemon-like aroma and lemon flower-like aroma were balanced well.
3 points: Lemon-like aroma and lemon flower-like aroma were balanced to some extent.
2 points: Lemon-like aroma and lemon flower-like aroma were balanced rather poorly.
1 point: Lemon-like aroma and lemon flower-like aroma were not balanced at all.

Tables 1 and 2 show the specifications of each sample and the results of the evaluations.

TABLE 1

| Sample No. | 1-1 | 1-2 | 1-3 | 1-4 | 1-5 | 1-6 | 1-7 |
|---|---|---|---|---|---|---|---|
| Citral (ppb) | 1000 | 1000 | 1000 | 1000 | 1000 | 1000 | 1000 |
| Methylanthranilate (ppb) | 0 | 30 | 50 | 500 | 1000 | 3000 | 5000 |
| Lemon-Like Character | 2.7 | 2.7 | 3.0 | 2.0 | 2.3 | 2.0 | 2.3 |
| Lemon Flower-Like | 1.0 | 2.0 | 2.7 | 4.0 | 4.0 | 4.3 | 4.7 |
| Character | | | | | | | |
| Overall Evaluation | 2.0 | 2.3 | 3.3 | 3.7 | 3.7 | 3.0 | 2.0 |

TABLE 2

| Sample No. | 2-1 | 2-2 | 2-3 | 2-4 | 2-5 | 2-6 | 2-7 | 2-8 | 2-9 |
|---|---|---|---|---|---|---|---|---|---|
| Citral (ppb) | 0 | 10 | 100 | 200 | 500 | 1000 | 5000 | 10000 | 20000 |
| Methylanthranilate (ppb) | 200 | 200 | 200 | 200 | 200 | 200 | 200 | 200 | 200 |
| Lemon-Like Character | 1.7 | 2.0 | 2.3 | 2.0 | 2.7 | 3.7 | 4.3 | 4.3 | 5.0 |
| Lemon Flower-Like Character | 1.7 | 2.7 | 3.0 | 3.0 | 3.7 | 3.0 | 3.0 | 3.0 | 3.0 |
| Overall Evaluation | 1.3 | 2.3 | 3.0 | 3.3 | 4.0 | 4.0 | 3.7 | 3.3 | 2.7 |

### (Review of Results)

As is obvious by reviewing the results of samples 1-1 to 1-7, it can be observed that a lemon flower-like character (lemon flower-like aroma) was sensed when the content of methylanthranilate was within a predetermined range. Specifically, the scores on the lemon flower-like character of the samples 1-2 to 1-7 were 2.0 and above.

Also, as is obvious by reviewing the results of the samples 1-1 to 1-7, it can be observed that, when the content of methylanthranilate was within a predetermined range, the score on the overall evaluation was good and a balanced aroma was sensed. Specifically, it can be observed that the scores on the overall evaluation of the samples 1-3 to 1-6 were better than the score on the overall evaluation of the sample 1-1 (2.0), and balanced and favorable lemon flower-like aromas were sensed.

As is obvious by reviewing the results of samples 2-1 to 2-9, it can be observed that the higher the content of citral, the stronger the lemon-like character of the aroma was sensed. Note that the scores on the lemon flower-like character of the samples 2-2 to 2-9 were 2.0 and above.

Also, as is obvious by reviewing the results of the samples 2-1 to 2-9, it can be observed that, when the content of citral was a predetermined value or more, the score on the overall evaluation was good and a balanced aroma was sensed. Specifically, it can be observed that the scores on the overall evaluation of the samples 2-3 to 2-9 were better than the score on the overall evaluation of the sample 2-1 (1.3) and balanced and favorable lemon flower-like aromas were sensed.

The above results show that a lemon-flavored beverage has a lemon flower-like aroma when containing citral and methylanthranilate in amounts within the respective predetermined ranges specified in the present invention.

### Example 2

Next, in example 2, the impact of the contents of citral and indole on evaluations will be checked.

### (Preparation of Samples)

Sample liquids were prepared by mixing citral, indole, and distilled water.

### (Contents of Test, Evaluation Criterion)

The contents of the test and the evaluation criterion were the same as those in example 1.

Tables 3 and 4 show the specifications of each sample and the results of the evaluations.

TABLE 3

| Sample No. | 3-1 | 3-2 | 3-3 | 3-4 | 3-5 | 3-6 | 3-7 | 3-8 | 3-9 | 3-10 |
|---|---|---|---|---|---|---|---|---|---|---|
| Citral (ppb) | 1000 | 1000 | 1000 | 1000 | 1000 | 1000 | 1000 | 1000 | 1000 | 1000 |
| Indole (ppb) | 0 | 1 | 2 | 5 | 10 | 20 | 50 | 100 | 200 | 500 |
| Lemon-Like Character | 2.0 | 2.0 | 2.0 | 2.0 | 2.3 | 2.3 | 2.3 | 2.0 | 1.7 | 1.7 |
| Lemon Flower-Like Character | 1.0 | 1.7 | 2.0 | 2.3 | 2.7 | 3.0 | 3.3 | 4.0 | 4.3 | 4.3 |
| Overall Evaluation | 1.7 | 1.3 | 1.7 | 1.7 | 2.7 | 3.0 | 3.7 | 2.7 | 2.7 | 1.7 |

TABLE 4

| Sample No. | 4-1 | 4-2 | 4-3 | 4-4 | 4-5 | 4-6 | 4-7 | 4-8 | 4-9 |
|---|---|---|---|---|---|---|---|---|---|
| Citral (ppb) | 0 | 10 | 100 | 200 | 500 | 1000 | 5000 | 10000 | 20000 |
| Indole (ppb) | 50 | 50 | 50 | 50 | 50 | 50 | 50 | 50 | 50 |
| Lemon-Like Character | 1.7 | 1.7 | 2.3 | 3.0 | 3.3 | 3.7 | 4.7 | 4.7 | 5.0 |
| Lemon Flower-Like Character | 2.7 | 3.0 | 3.3 | 3.0 | 2.7 | 3.0 | 3.0 | 2.3 | 2.3 |
| Overall Evaluation | 1.7 | 1.7 | 2.7 | 3.3 | 4.0 | 4.3 | 3.3 | 2.7 | 2.0 |

### (Review of Results)

As is obvious by reviewing the results of samples 3-1 to 3-10, it can be observed that a lemon flower-like character (lemon flower-like aroma) was sensed when the content of indole was within a predetermined range. Specifically, the scores on the lemon flower-like character of the samples 3-3 to 3-10 were 2.0 and above.

Also, as is obvious by reviewing the results of the samples 3-1 to 3-10, it can be observed that, when the content of indole was within a predetermined range, the score on the overall evaluation was good and a balanced aroma was sensed. Specifically, it can be observed that the scores on the overall evaluation of the samples 3-5 to 3-9 were better than the score on the overall evaluation of the sample 3-1 (1.7) and balanced and favorable lemon flower-like aromas were sensed.

As is obvious by reviewing the results of samples 4-1 to 4-9, it can be observed that the higher the content of citral, the stronger the lemon-like character of the aroma was sensed.

Note that the scores on the lemon flower-like character of the samples 4-2 to 4-9 were 2.0 and above.

Also, as is obvious by reviewing the results of the samples 4-1 to 4-9, it can be observed that, when the content of citral was a predetermined value or more, the score on the overall evaluation was good and a balanced aroma was sensed. Specifically, it can be observed that the scores on the overall evaluation of the samples 4-3 to 4-9 were better than the score on the overall evaluation of the sample 4-1 (1.7) and balanced and favorable lemon flower-like aromas were sensed.

The above results show that a lemon-flavored beverage has a lemon flower-like aroma when containing citral and indole in amounts within the respective predetermined ranges specified in the present invention.

### Example 3

Next, in example 3, the impact of containing citral and both methylanthranilate and indole on evaluations will be checked.

### (Preparation of Sample)

A sample liquid was prepared by mixing citral, methylanthranilate, indole, and distilled water.

### (Contents of Test, Evaluation Criterion)

The contents of the test and the evaluation criterion in the test were the same as those in example 1.

Table 5 show the specifications of the sample and the results of the evaluations.

TABLE 5

| Sample No. | 5-1 |
|---|---|
| Citral (ppb) | 1000 |
| Methylanthranilate (ppb) | 200 |
| Indole (ppb) | 50 |
| Lemon-Like Character | 2.7 |
| Lemon Flower-Like Character | 4.0 |
| Overall Evaluation | 3.3 |

### (Review of Result)

As is obvious by reviewing the result of a sample 5-1, it can be observed that a lemon flower-like aroma was sensed also when citral and both methylanthranilate and indole were contained in the beverage.

### Example 4

Next, in example 4, the tastes and aromas of a “near water”, a “carbonated beverage”, and an “alcoholic beverage (RTD)” employing the present invention will be checked.

### (Preparation of Sample: Near Water)

A sample liquid (near water) was prepared by mixing a high-fructose corn syrup (New Craft 55 by Showa Sangyo Co., Ltd.) by 8.0 w/w %, citric acid (anhydrous: JUNSEI CHEMICAL CO., LTD.) by 0.06 w/w %, sodium citrate (Wako Pure Chemical Industries, Ltd.) by 0.01 w/w %, citral by 0.0001 w/w %, methylanthranilate by 0.00002 w/w %, indole by 0.000005 w/w %, and distilled water.

### (Preparation of Sample: Carbonated Beverage)

A sample liquid (carbonated beverage with a gas pressure of 2.5 kg/cm² at 20° C.) was prepared by mixing a high-fructose corn syrup (New Craft 55 by Showa Sangyo Co. , Ltd.) by 8.0 w/w %, citric acid (anhydrous: JUNSEI CHEMICAL CO. , LTD.) by 0.06 w/w %, sodium citrate (Wako Pure Chemical Industries, Ltd.) by 0.01 w/w %, citral by 0.0001 w/w %, methylanthranilate by 0.00002 w/w %, indole by 0.000005 w/w %, and carbonated water.

### (Preparation of Sample: Alcoholic Beverage)

A sample liquid (alcoholic beverage with a gas pressure of 2.5 kg/cm² at 20° C.) was prepared by mixing a high-fructose corn syrup (New Craft 55 by Showa Sangyo Co. , Ltd.) by 8.0 w/w %, citric acid (anhydrous: JUNSEI CHEMICAL CO. , LTD.) by 0.06 w/w %, sodium citrate (Wako Pure Chemical Industries, Ltd.) by 0.01 w/w %, a raw alcohol (65.5% alcohol) by 6.8 w/w %, citral by 0.0001 w/w %, methylanthranilate by 0.00002 w/w %, indole by 0.000005 w/w %, and carbonated water.

### (Contents of Test)

Three trained professional panelists checked the aromas of the samples produced by the above methods (checked their so-called top notes) without drinking them, and then checked their tastes and aromas by drinking them.

### (Evaluation of Near Water)

From the near water produced by the above method, a lemon flower-like aroma was sensed as its top note. Also, an aroma with a lemon-like character and a lemon flower-like character was sensed from immediately after the near water was put into the mouth to after the near water was swallowed.

### (Evaluation of Carbonated Beverage)

From the carbonated beverage produced by the above method, a lemon flower-like aroma was sensed as its top note. Also, an aroma with a lemon flower-like character was sensed from immediately after the carbonated beverage was put into the mouth to after the carbonated beverage was swallowed.

### (Evaluation of Alcoholic Beverage)

From the alcoholic beverage produced by the above method, a lemon flower-like aroma was sensed as its top note. Also, an aroma with a lemon flower-like character was sensed from immediately after the alcoholic beverage was put into the mouth to after the alcoholic beverage was swallowed, and this sensed aroma lingered for a long time.

### REFERENCE SIGNS LIST

S1 mixing step
S2 post-processing step

1. A lemon-flavored beverage satisfying
a condition that a content of citral is 10 to 20000 ppb, and
at least one of a condition that a content of methylanthranilate is 30 to 5000 ppb and a condition that a content of indole is 2 to 500 ppb.

2. The lemon-flavored beverage according to claim 1, wherein the content of citral is 100 to 10000 ppb.

3. The lemon-flavored beverage according to claim 1, wherein the content of methylanthranilate is 50 to 3000 ppb.

4. The lemon-flavored beverage according to claims 1, wherein the content of indole is 10 to 200 ppb.

5. The lemon-flavored beverage according to any one of claims 1 to 4, wherein the lemon-flavored beverage contains alcohol.

6. A lemon-flavored beverage base containing citral and at least one of methylanthranilate and indole, wherein, in a case where a content of the citral is X ppb, a content of the methylanthranilate is Y ppb, a content of the indole is Z ppb, and a dilution ratio is D fold, the lemon-flavored beverage base satisfies a condition that X/D is 10 to 20000 and at least one of a condition that Y/D is 30 to 5000 and a condition that Z/D is 2 to 500.

7. A method for producing a lemon-flavored beverage, comprising the step of setting a content of citral and a content of at least one of methylanthranilate and indole within following respective ranges:
(1) the content of citral: 10 to 20000 ppb;
(2) the content of methylanthranilate: 30 to 5000 ppb; and
(3) the content of indole: 2 to 500 ppb.

8. A method for producing a lemon-flavored beverage base containing citral and at least one of methylanthranilate and indole, comprising the step of, in a case where a content of the citral is X ppb, a content of the methylanthranilate is Y ppb, a content of the indole is Z ppb, and a dilution ratio is D fold, setting X/D and at least one of Y/D and Z/D within following ranges:
(1) the X/D: 10 to 20000;
(2) the Y/D: 30 to 5000; and
(3) the Z/D: 2 to 500.

9. A method for improving a flavor of a lemon-flavored beverage, comprising adjusting a content of citral and a content of at least one of methylanthranilate and indole in the lemon-flavored beverage such that the contents are within following respective ranges:
(1) the content of citral: 10 to 20000 ppb;
(2) the content of methylanthranilate: 30 to 3000 ppb; and
(3) the content of indole: 2 to 500 ppb.
